(19) United States
(12) Patent Application Publication
(10) Pub. No.: US 2017/0078038 A1
(43) Pub. Date: Mar. 16, 2017

(54) CLOCK SYNCHRONIZATION MANAGEMENT DEVICE, CONTROL METHOD AND COMPUTER PROGRAM PRODUCT

(71) Applicant: Kabushiki Kaisha Toshiba, Minato-ku, Tokyo (JP)

(72) Inventors: Taichi TASHIRO, Fuchu Tokyo (JP); Keiji YAMAMOTO, Ome Tokyo (JP); Masashi ISHIDA, Fuchu Tokyo (JP); Kohta NAKAMURA, Fuchu Tokyo (JP)

(21) Appl. No.: 15/125,954

(22) PCT Filed: Dec. 8, 2014
(86) PCT No.: PCT/JP2014/082451

§ 371 Date: Sep. 13, 2016

(30) Foreign Application Priority Data
Mar. 14, 2014 (JP) 2014-051042

(51) Int. Cl. H04J 3/06; H04W 56/00

(52) U.S. Cl. CPC H04J 3/0641; H04W 56/0015; H04J 3/0658

(57) ABSTRACT

According to an embodiment, a clock synchronization management device includes an accuracy evaluation unit and a network formation unit. The accuracy evaluation unit evaluates the accuracy of a clock for synchronization with respect to each of devices constituting a decentralization system and classifies each of the devices into a plurality of divisions based on whether each of the devices is capable of supplying at least the clock for synchronization to another device. The network formation unit identifies a device capable of supplying the clock for synchronization based on a classification by the accuracy evaluation unit and causes a device incapable of supplying the clock for synchronization to another device to synchronize with the identified device.

### FIELD

An embodiment of the present invention relates to a clock synchronization management device, a control method for a clock synchronization management device, and a control program.

### BACKGROUND

In the present day when there is a movement to replace a current public network with an IP network through a next generation IP network technique called a next generation network (NGN), communication companies are working on the shift to IP communication and optical communication. In accordance with this, an increasing tendency in the number of subscribers of IP telephony is marked every year. Furthermore, as represented by a cloud technique, a demand for free decentralization of devices on the IP network has been rising.

### CITATION LIST

### Patent Literature

Patent Literature 1: Japanese Laid-open Patent Publication No. 2001-244918

### SUMMARY OF THE INVENTION

### Problem to be Solved by the Invention

Meanwhile, when network devices are decentralized to be arranged on a network, it is difficult to guarantee a high-precise clock from the viewpoint of cost and the like in a case where, for example, an interface for a clock synchronization network cannot be provided to a terminal device or a case where a high-precise crystal oscillator or GPS is not equipped therein.

In such a case, this terminal device needs to use a synchronization approach on an IP network. However, when an appropriate clock master cannot be selected, it is not possible to guarantee a high-precise clock. For this reason, it has been desired to select an appropriate clock master.

Moreover, it has been also desired to select an appropriate clock master in accordance with an increase in number of devices forming a decentralization arrangement system, a change in device environment, and so on.

The present invention has been made by taking the above point in consideration and an object thereof is to provide a clock synchronization management device, a control method for a clock synchronization management device, and a control program capable of appropriately selecting a clock master and capable of selecting an appropriate clock master in accordance with an increase in number of devices forming a decentralization arrangement system, a change in device environment, and so on.

### Means for Solving Problem

An accuracy evaluation unit of a clock synchronization management device according to an embodiment evaluates the accuracy of a clock for synchronization with respect to each of devices constituting a decentralization system and classifies each of the devices into a plurality of divisions based on whether each of the devices is capable of supplying at least the clock for synchronization to another device.

Thereby, a network formation unit identifies a device capable of supplying the clock for synchronization based on the classification according to the accuracy evaluation unit and causes a device incapable of supplying the clock for synchronization to another device to synchronize with the identified device.

### BRIEF DESCRIPTION OF DRAWINGS

FIG. 1 is a configuration diagram illustrating an overview of a communication system according to an embodiment.

FIG. 2 is a configuration diagram illustrating devices constituting the communication system.

FIG. 3 is an explanatory diagram for exemplary operation for clock master determination.

FIG. 4 is an explanatory diagram for exemplary operation for forming a clock synchronization network.

FIG. 5 is an explanatory diagram for assignment of a sub clock master candidate.

FIG. 6 is an explanatory diagram for exemplary clock synchronization operation.

FIG. 7 is an explanatory diagram for exemplary operation when a failure occurs.

FIG. 8A is an explanatory diagram (No. 1) for an exemplary clock synchronization approach using a plurality of communication paths.

FIG. 8B is an explanatory diagram (No. 2) for the exemplary clock synchronization approach using the plurality of communication paths.

FIG. 9 is an operation sequence diagram for clock synchronization network formation when a new network device is added.

FIG. 10 is an explanatory diagram for an exemplary operation sequence when a clock synchronization network is updated in accordance with clock accuracy evaluation and failure information.

### DETAILED DESCRIPTION

Hereinafter, an embodiment will be described with reference to drawings.

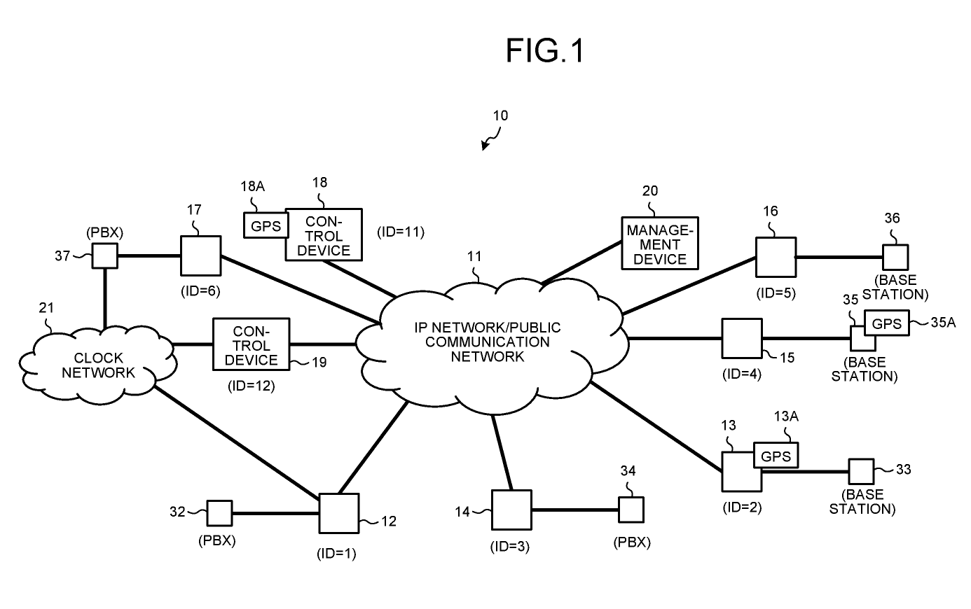

FIG. 1 is a configuration diagram illustrating an overview of a communication system according to the embodiment.

In the following description, it is assumed that high-precise clock accuracy represents enough accuracy to perform voice communication through an ISDN. Meanwhile, it is assumed that medium-precise clock accuracy represents accuracy not considered as being enough to perform the voice communication through the ISDN but causing no difficulty therein. Additionally, it is assumed that low-precise clock accuracy represents accuracy at such a level that no problem is caused in performing data communication and VoIP communication but voice quality is deteriorated in the voice communication through the ISDN.

As illustrated in FIG. 1, a communication system 10 includes an IP network/public communication network 11 constituting a so-called WAN, multiple network devices 12 to 17 each being connected to the IP network/public communication network 11 and functioning as a so-called access point, multiple control devices 18 and 19 each being connected to the IP network/public communication network 11, a management device 20 connected to the IP network/public communication network 11, and a clock network 21 capable of supplying a clock signal having high-precise clock accuracy.

Additionally, the communication system 10 includes a local terminal 32 connected to the network device 12 and configured as a PBX, a local terminal 33 connected to the network device 13 and configured as a base station, a local terminal 34 connected to the network device 14 and configured as a PBX, a local terminal 35 connected to the network device 15 and configured as a base station having a GPS (device) 35A, a local terminal 36 connected to the network device 16 and configured as a base station, and a local terminal 37 connected to the network device 17 and the clock network 21 and configured as a PBX.

In the configuration described above, each of the control devices 18 and 19 controls a certain network device and accepts clock synchronization from the network device via the IP network.

In addition, the control device 18 includes a GPS (device) 18A. Meanwhile, the control device 19 is connected to the clock network 21.

Furthermore, the GPS 18A and the GPS 35A generate high-precise clocks.

In the configuration described above, the network device 12, the control device 19, and the local terminal 37 each being connected to the clock network 21 extract a clock from the clock network 21.

The control device 18, the network device 13, and the local terminal 35 each including a GPS also extract a clock from the GPS 18A, a GPS 13A, and the GPS 35A.

In addition, the network devices 15 and 17, of which the local terminal is provided with a GPS or of which the local terminal is connected to the clock network 21, extract a clock from the local terminals 35 and 37, respectively.

In a case where a network device incapable of extracting a clock in any manner described above can extract a clock from the local terminal connected to the own network device because this local terminal is provided with a GPS or connected to the clock network 21, a clock is extracted from this local terminal. Meanwhile, in a case where a network device cannot extract a clock from the local terminal connected to the own network device, the clock synchronization is performed via the IP network/public communication network 11. In this case, as a procedure for the clock synchronization via the IP network, for example, a precision time protocol (PTP) defined in IEEE1588 can be employed.

Additionally, while managing system information on the network devices 12 to 17, the management device 20 dynamically forms a clock synchronization network and instructs the network devices 12 to 17 as necessary to perform the clock synchronization via the IP network/public communication network 11.

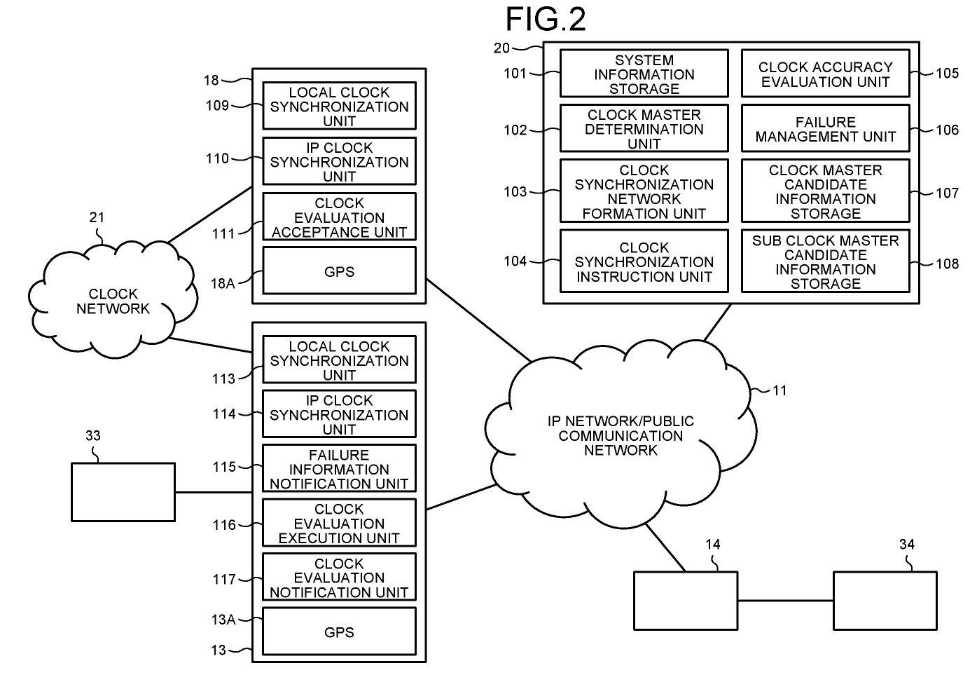

FIG. 2 is a configuration diagram illustrating the devices constituting the communication system.

First, a configuration of the management device 20 will be described.

The management device 20 includes a system information storage 101, a clock master determination unit 102, and a clock synchronization network formation unit 103. The system information storage 101 stores system information on the network devices 12 to 17 and the control devices 18 and 19 (e.g., a PBX telephone number, a base station paging area ID, an IP address, geographic information). The clock master determination unit 102 determines a clock master which is a device capable of generating a high-precise clock serviceable as a clock synchronization source and a sub clock master which is a device capable of generating a medium-level clock serviceable as a clock synchronization source. The clock synchronization network formation unit 103 forms a clock synchronization network on the basis of a determination result from the clock master determination unit 102.

The management device 20 also includes a clock synchronization instruction unit 104 and a clock accuracy evaluation unit 105. The clock synchronization instruction unit 104 selects, on the basis of clock master candidate information and sub clock master candidate information, a combination of the devices between which the clock synchronization is performed and then instructs the network devices 12 to 17 and the control devices 18 and 19 to perform the clock synchronization. The clock accuracy evaluation unit 105 collects clock evaluation information from the network device selected as the clock master to update the clock master candidate information and the sub clock master candidate information and then re-forms the clock synchronization network.

The management device 20 further includes a failure management unit 106, a clock master candidate information storage 107, and a sub clock master candidate information storage 108. The failure management unit 106 updates, on the basis of failure information on the network devices 12 to 17, the clock master candidate information in the clock master candidate information storage 107 described later and the sub clock master candidate information in the sub clock master candidate information storage 108 described later and then re-forms the clock synchronization network. The clock master candidate information storage 107 stores information on a device serviceable as the clock master on the basis of the evaluation by the clock accuracy evaluation unit 105. The sub clock master candidate information storage 108 stores, on the basis of the evaluation by the clock accuracy evaluation unit 105, information on a device serviceable as the sub clock master which is a device capable of generating a medium-precise clock serviceable as a clock synchronization source.

Next, a configuration of the control device will be described.

Because the control device 18 and the control device 19 have similar configurations to each other, the control device 18 will be described as an example.

The control device 18 includes a local clock synchronization unit 109, an IP clock synchronization unit 110, a clock evaluation acceptance unit 111, and the GPS 18A. The local clock synchronization unit 109 synchronizes with a clock generated by the GPS or the clock network 21 in a case where the control device 18 itself or the local terminal connected thereto is provided with the GPS or connected to the clock network 21. The IP clock synchronization unit 110 synchronizes with a clock generated by another device on the IP network/public communication network 11 in a case where the local clock synchronization unit 109 has no clock to be synchronized with. The clock evaluation acceptance unit 111 establishes a communication path to the network device that undergoes clock evaluation.

Next, a configuration of the network device will be described.

In the following description, because the network devices 12 to 17 have similar configurations to one another, the network device 13 will be described as an example.

The network device 13 includes a local clock synchronization unit 113, an IP clock synchronization unit 114, a failure information notification unit 115, a clock evaluation execution unit 116, a clock evaluation notification unit 117, and the GPS 13A. The local clock synchronization unit 113 synchronizes with a clock generated by the GPS or the clock network 21 in a case where the network device 13 itself or the local terminal connected thereto is provided with the GPS or connected to the clock network 21. The IP clock synchronization unit 114 synchronizes with a clock generated by the IP network/public communication network 11 in a case where the local clock synchronization unit 109 has no clock to be synchronized with. The failure information notification unit 115 notifies the management device 20 of the failure information via the IP network/public communication network 11. The clock evaluation execution unit 116 evaluates a clock under the control of the management device 20. The clock evaluation notification unit 117 notifies the management device 20 of a result of the clock evaluation performed by the clock evaluation execution unit 116.

Each of the network devices 12 to 17 employs one of the following configurations (1) to (4) by device configuration.

(1) A configuration with a connection interface (I/F) with the clock network 21

In the example in FIG. 1, this applies to the network device 12.

(2) A configuration with the GPS provided in the own device

In the example in FIG. 1, this applies to the network device 13.

(3) A configuration capable of extracting a clock from the local terminal connected to the own device

In the example in FIG. 1, this applies to the network device 15 and the network device 17.

(4) A configuration without any clock source

In the example in FIG. 1, this applies to the network device 14 and the network device 16.

The network devices applicable to (1) to (3) above, namely, the network devices 12, 13, 15, and 17 in the aforementioned example are accordingly to extract a clock using the local clock synchronization unit 113 when performing the synchronization.

Meanwhile, the network devices applicable to (4) above, namely, the network device 14 and the network device 16 in the aforementioned example receive a clock synchronization instruction from the management device 20 and then performs the clock synchronization with a device specified by the IP clock synchronization unit 114 via the IP network out of the IP network/public communication network 11.

In addition, in a case where an instruction on the clock evaluation is given through information included in the clock synchronization instruction from the management device 20, each of the network devices 12 to 17 evaluates a clock between the own device and a device specified by the clock evaluation execution unit 116 and notifies the management device 20 of a measurement result via the clock evaluation notification unit 117.

Next, operation for clock master determination at the clock master determination unit of the management device will be described.

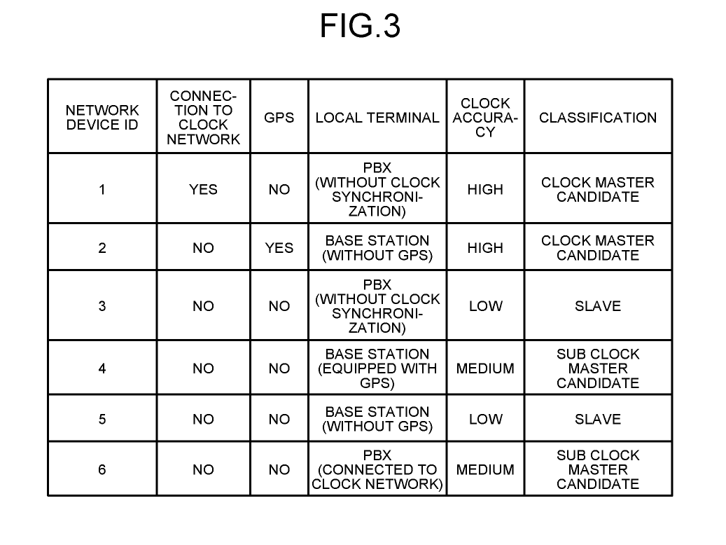

FIG. 3 is an explanatory diagram for exemplary operation for clock master determination.

The clock master determination unit 102 of the management device 20 determines the clock accuracy on the basis of the system information on the network devices 12 to 17.

More specifically, the clock master determination unit 102 of the management device 20 determines the clock accuracy as being high in a case where the respective network devices 12 to 17 are connected to the clock network 21 or the respective network devices 12 to 17 are equipped with the GPS and then, as illustrated in FIG. 3, classifies the applicable network device into a clock master candidate while storing the system information on this network device to the clock master candidate information storage.

Additionally, in the clock master determination unit 102 of the management device 20, in a case where the respective network devices 12 to 17 are not connected to the clock network 21 and the respective network devices 12 to 17 are not equipped with the GPS, the clock master determination unit 102 of the management device 20 determines the clock master on the basis of local terminal information constituted by the system information on the local terminals connected to the respective network devices 12 to 17.

In the example in FIG. 1, the PBX and the base station are assumed as examples of the local terminals connected to the network devices.

Incidentally, when configured as high-performance devices, the PBX and the base station are provided with the connection interface (I/F) with the clock network 21, equipped with the GPS, or provided with the high-precise clock.

Accordingly, in the embodiment, the network devices to which the high-performance PBX or base station is connected as the local terminal (the network device 15 and the network device 17 in the example in FIG. 1) are assumed to be supplied with the clock from the local terminals 35 and 37 and thus, the clock accuracy thereof is determined as being medium-precise. Thereafter, as illustrated in FIG. 3, these network devices are classified into a sub clock master candidate to be set as the clock master as a substitute in a case where the clock master candidate has a high connection load, while the system information on these network devices is stored to the sub clock master candidate information storage 108.

On the other hand, in a case where the network devices are not connected to the clock network 21 and the network devices do not equipped with the GPS, as for the network devices not supplied with the clock from the local terminals connected to the network devices (the network devices 14 and 16 in the example in FIG. 1), the management device 20 classifies these network devices as slaves, as illustrated in FIG. 3.

As described above, on the basis of the system information collected together in the system information storage 101 to be stored therein, the management device 20 retrieves classification information used in selecting whether the clock synchronization is required for the respective network devices 12 to 17 and selecting the respective network devices 12 to 17 as the clock master or the slave.

Next, operation for forming the clock synchronization network according to the embodiment will be described.

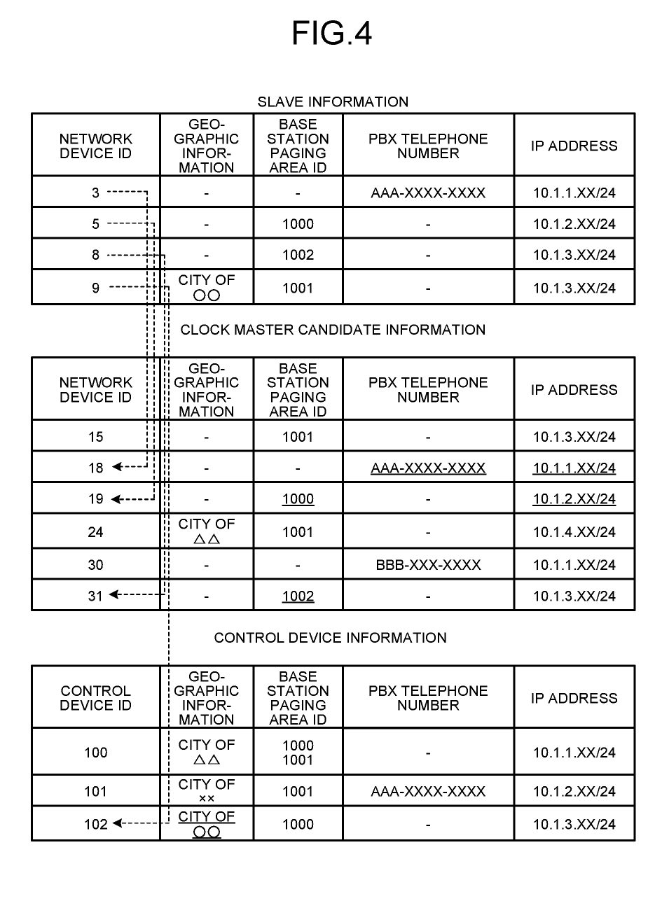

FIG. 4 is an explanatory diagram for exemplary operation for forming a clock synchronization network.

In the embodiment, on the basis of the result of the aforementioned clock master determination, the management device 20 selects a network device to serve as the clock master for the network device classified into the slave.

In the following description, a case where the PBX telephone number, the base station paging area ID, the IP address, and the geographic information are stored as the system information will be used as an example.

In this case, the management device 20 operates so as to put a higher priority on a device physically arranged more proximal (hereinafter, referred to as proximal device) when selecting the network device to serve as the clock master. This is because the proximal device is considered to be able to maintain the clock accuracy obtained when the clock synchronization is performed higher.

For this reason, in a case where the geographic information is registered as the system information, the management device 20 takes the geographic information into consideration with priority and accordingly selects the proximal device. As a result, the proximal device is selected with more ease.

In the embodiment, however, even in a case where the geographic information is unknown, the clock synchronization network can be formed by selecting a device with a strong possibility of being the proximal device.

Hereinafter, details will be described.

When the geographic information is unknown, the management device 20 uses the PBX telephone number, the base station paging area ID, or the IP address as a substituting means for the geographic information.

Here, in a case where the local terminal belonging to one of the network devices (12 to 17) is a PBX (the local terminal 32, the local terminal 34, and the local terminal 37 in the example in FIG. 1), the PBX telephone number is a telephone number registered in the local terminal as the system information.

Meanwhile, the base station paging area ID is an ID registered as the system information in a case where the local terminal belonging to the network device is a base station (the local terminal 33 and the local terminal 36 in the example in FIG. 1).

In addition, because there is a case where the control devices (18 and 19) have the plurality of PBXs or base stations belonging thereto, the PBX telephone numbers or the base station paging area IDs are registered to the system information in an overlapping manner.

The management device 20 evaluates the geographic information, the base station paging area, the PBX telephone number, and the IP address in this order as the degree of the priority for selecting a device located proximal.

Hereinafter, exemplary selection of the clock master will be described with reference to FIG. 4.

First, the management device 20 refers to slave information within the system information storage 101 to select the network device 14 with the network device ID=3 as a network device for which the clock master needs to be settled. Because the geographic information on the device with the network device ID=3 is unknown and no base station paging ID is provided therein, the clock synchronization network formation unit 103 of the management device 20 consequently uses the PBX telephone number for the evaluation.

Specifically, the clock synchronization network formation unit 103 determines devices for which telephone numbers with the same high-order digits of the PBX telephone numbers are registered as being proximal to each other. More specifically, the clock synchronization network formation unit 103 selects, as candidates, a network device with the network device ID=18 (not illustrated) in the clock master candidate information and a control device with the control device ID=101 (not illustrated) in control device information.

Next, the clock synchronization network formation unit 103 evaluates on the basis of the IP address and then selects, as the clock master, the network device with the network device ID=18 which is a member of the same network.

Likewise, on the basis of information on the base station paging area ID and the IP address, the clock synchronization network formation unit 103 selects a network device with the network device ID=19 as the clock master for the network device 16 with the network device ID=5.

In addition, on the basis of the base station paging area ID, the clock synchronization network formation unit 103 selects a network device with the network device ID=31 (not illustrated) for a network device with the network device ID=8 (not illustrated).

Furthermore, because the geographic information is registered for a network device with the network device ID=9 (not illustrated), the clock synchronization network formation unit 103 selects, as the clock master therefor, a control device with the control device ID=102 (not illustrated) having the same geographic information.

As described above, the clock synchronization network formation unit 103 of the management device 20 selects a device from the candidates for the clock master depending on the system information to form the clock synchronization network.

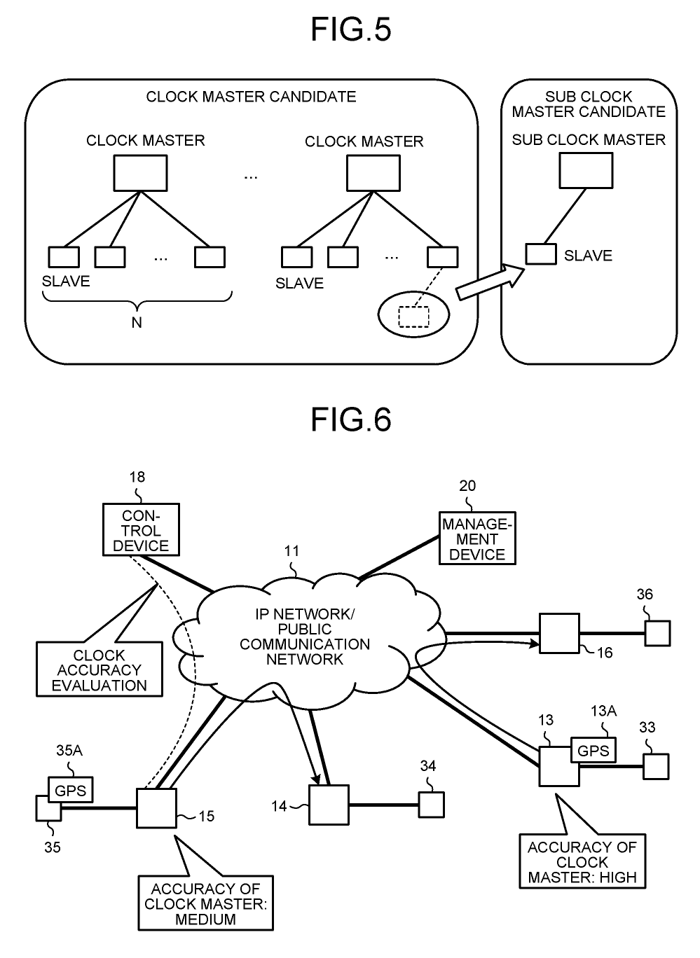

FIG. 5 is an explanatory diagram for assignment of the sub clock master candidate.

Incidentally, from the viewpoint of ensuring the clock accuracy, an upper limit value is provided in the number of the devices that can be directly connected for the clock synchronization.

Here, when the upper limit value of the number of the devices that can be directly connected for the clock synchronization is assumed as N, there is a case where all of the devices registered in the clock master candidate reach the upper limit value N as illustrated in FIG. 5.

Meanwhile, when the clock synchronization network is structured as having multiple levels for the purpose of the registration to the clock master, the clock accuracy of a slave at a low position is lowered.

For a solution to this, on the basis of the sub clock master candidate information registered in the sub clock master candidate information storage 108, the clock synchronization network formation unit 103 of the management device 20 selects the clock master from the registered network devices to assign, thereby avoiding the multiple level structure of the clock synchronization network.

In the description above, a case where the geographic information, the base station paging area ID, the PBX telephone number, and the IP address are used as the system information has been described. However, the usable system information is not limited to the above. For example, various types of the system information serving as substitutes for the geographic information can be used.

Next, more specific clock synchronization operation will be described.

FIG. 6 is an explanatory diagram for exemplary clock synchronization operation.

The clock synchronization instruction unit 104 of the management device 20 instructs a combination of the clock master and the slave settled at the clock synchronization network formation unit 103 to start the clock synchronization via the IP network, while notifying one of the combination of device information on the other and conversely.

At this time, the clock master for which the clock accuracy has been determined as being high-precise is instructed to perform usual clock synchronization. As for the clock master for which the clock accuracy has been determined as being medium-precise, there is a possibility of the clock accuracy being affected (the degradation of the clock accuracy) depending on a state of the local terminal.

For a solution to this, the failure management unit 106 of the management device 20 manages the system information on the local terminal on the basis of the failure information communicated by the failure information notification unit 115 of the network device and monitors whether the clock extraction can be continued. Additionally, the failure management unit 106 of the management device 20 instructs the clock master for which the clock accuracy has been determined as being medium-precise to undergo the clock accuracy evaluation.

Here, the clock accuracy of this clock master (network device) to be evaluated is evaluated in reference to the control device capable of guaranteeing the high-precise clock (for example, the control device 18 in the example in FIG. 6).

The network device serving as the clock master to be evaluated establishes the communication path to the control device capable of guaranteeing the high-precise clock at every certain interval and measures a difference in communication through packet drop or the like to notify the management device 20 thereof.

The clock accuracy evaluation unit 105 of the management device 20 evaluates the clock accuracy and determines the network device with the clock accuracy equal to or lower than a threshold as being inappropriate as the clock master. Thereafter, the clock accuracy evaluation unit 105 changes the clock accuracy thereof to low-precision (sets the clock accuracy thereof as being low-precise) and at the same time, removes the system information (sub clock master candidate information) on this network device (device) from the sub clock master candidate information.

In parallel to this, the clock synchronization network formation unit 103 of the management device 20 selects a new clock master device for the slave device whose clock master has been set to the network device (device) for which the sub clock master candidate information has been removed from the sub clock master candidate information storage 108 and also for the network device (device) itself for which the sub clock master candidate information has been removed. Additionally, the clock synchronization network formation unit 103 of the management device 20 instructs the slave device whose clock master has been set to the network device (device) for which the sub clock master candidate information has been removed and the network device (device) for which the sub clock master candidate information has been removed to perform the clock synchronization, thereby re-forming the clock synchronization network.

As a result, a new clock synchronization network from which the clock master (network device) having the clock accuracy determined as being low-precise has been removed is formed.

Next, operation of the network device or the local terminal connected to the network device when a failure occurs will be described. Although description will not be given below, similar processing is performed in the control device when a failure occurs.

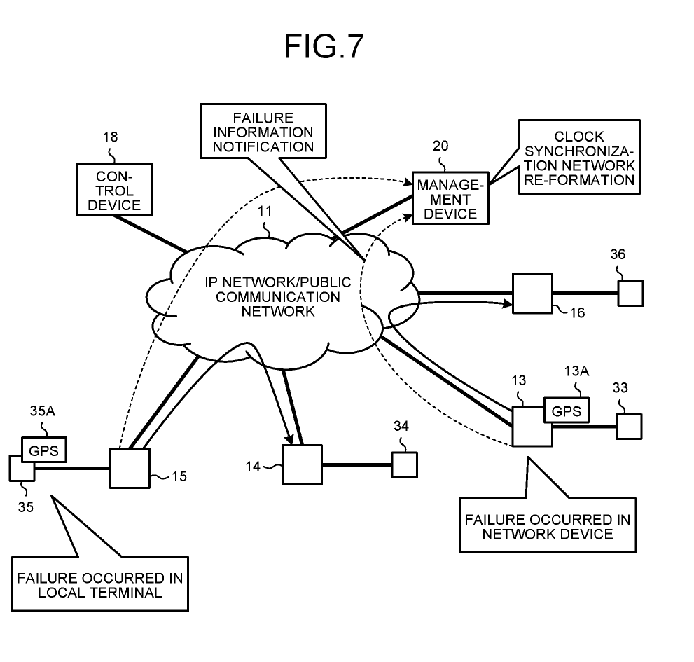

FIG. 7 is an explanatory diagram for exemplary operation when a failure occurs.

Each of the network devices 12 to 17 notifies the failure management unit 106 of the management device 20 of information on a failure of its own or a failure in the local terminal connected to the own device as a failure information notification.

As a result, in a case where the network device that has communicated the failure information serves as the clock master, the failure management unit 106 of the management device 20 determines, on the basis of the failure information, whether the clock extraction is to be disabled.

For example, in a case where a connection failure to the clock network or a GPS failure occurs in the network device itself, the failure management unit 106 changes the evaluation (determination) information on the clock accuracy thereof to low from high. The failure management unit 106 also removes the system information on this network device (device) from the clock master candidate information storage 107. Meanwhile, in a case where a failure in the local terminal occurs in the network device that extracts a clock from the local terminal, the failure management unit 106 changes the evaluation (determination) information on the clock accuracy thereof to low from medium, while removing the system information on this network device (device) from the sub clock master candidate information storage 108.

Additionally, the clock synchronization network formation unit 103 of the management device 20 selects a new clock master device for the slave device whose clock master has been set to the network device for which the system information has been removed and also for the network device itself for which the system information has been removed from the sub clock master candidate information storage 108. Furthermore, the clock synchronization network formation unit 103 gives an instruction on the clock synchronization to re-form the clock synchronization network. Consequently, it is made possible to continuously maintain an appropriate clock synchronization network dynamically in response to a failure as well.

Next, a clock synchronization approach using a plurality of communication paths will be described.

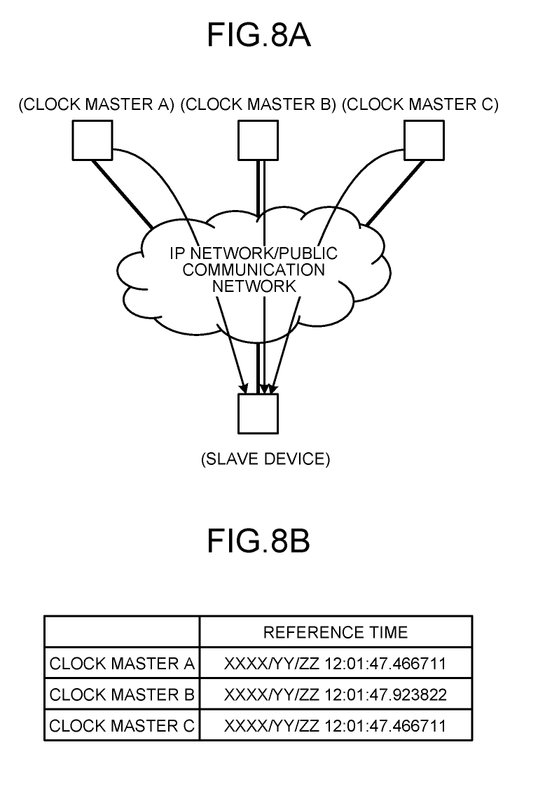

FIG. 8A is an explanatory diagram (No. 1) for an exemplary clock synchronization approach using a plurality of communication paths.

FIG. 8B is an explanatory diagram (No. 2) for the exemplary clock synchronization approach using the plurality of communication paths.

A device to serve as the sub clock master candidate (the network device or the control device) has a possibility of not necessarily being able to guarantee the clock accuracy.

Accordingly, the embodiment employs selection-type clock synchronization by majority rule using the plurality of clock masters. Hereinafter, the network device to serve as the sub clock master candidate will be described.

Specifically, in a case where the sub clock master candidate is set as a master when the network device to serve as the clock master is selected for the network device classified into the slave in accordance with the clock master determination by the clock master determination unit 102 of the management device 20, the clock synchronization network formation unit 103 makes a selection so as to create a combination of an odd number of the clock masters equal to or greater than three.

As a result, the network device acting as the slave simultaneously and parallelly performs the clock synchronization with the plurality of clock masters specified in the clock synchronization instruction from the clock synchronization instruction unit 104 of the management device 20 and, for example, acquires clock information such as reference time information.

Subsequently, the network device acting as the slave determines consistency among the clock information such as reference time information acquired from the plurality of clock masters (here, consistency includes being within an acceptable margin of error). Thereafter, in a case where different clock information is communicated by each of the plurality of clock masters, the network device acting as the slave determines the clock information containing a larger amount of the consistent (identical) information as the correct clock information and then performs the clock synchronization.

In the exemplary configuration in FIG. 8A, because reference time is consistent between a clock master A and a clock master C as illustrated in FIG. 8B, the network device acting as the slave is accordingly to perform the clock synchronization with the clock master A or the clock master C. In a case where the clock master cannot be selected for a reason that, for example, the reference time is not consistent among all of the clock masters, the synchronization is performed with the clock master which has been selected as the clock master the largest number of times in the past history.

As described above, even when the network device serving as the sub clock master candidate which cannot guarantee the clock accuracy is used, it is possible to form the clock synchronization network capable of guaranteeing the high-precise clock.

Next, operation for forming the clock synchronization network when a new network device is added will be described.

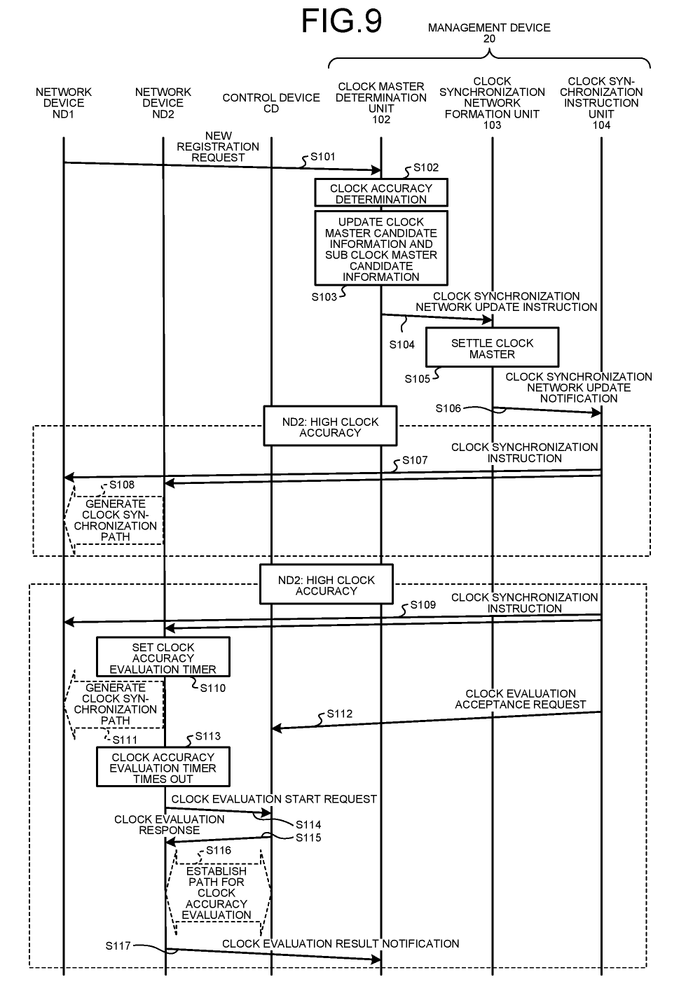

FIG. 9 is an operation sequence diagram for clock synchronization network formation when a new network device is added.

In FIG. 9, a newly added network device ND1 notifies the management device 20 of a new registration request along with the system information (step S101).

In response to this, the clock master determination unit 102 of the management device 20 determines the clock accuracy on the basis of the system information stored in the system information storage 101 (step S102).

In a case where the clock accuracy of the network device ND1 is high-precise in the determination in step S102, the clock master determination unit 102 updates the clock master information in the clock master candidate information storage 107. Meanwhile, in a case where the clock accuracy of the network device ND1 is medium-precise in the determination in step S102, the clock master determination unit 102 updates the sub clock master candidate information in the sub clock master candidate information storage 108 (step S103).

Thereafter, the clock master determination unit 102 of the management device 20 notifies the clock synchronization network formation unit 103 of a clock synchronization network update instruction (step S104).

In response to this, the clock synchronization network formation unit 103 settles the clock master on the basis of the system information, the clock master candidate information, and the sub clock master candidate information (step S105).

The clock master determination unit 102 also notifies the clock synchronization instruction unit 104 of a clock synchronization network update notification (step S106).

Here, by assuming that the newly added network device ND1 has the low-precise clock accuracy, a case where a network device ND2 is assigned thereto as the clock master will be described more specifically.

In a case where the network device ND2 serving as the clock master has the high-precise clock accuracy in this situation, the clock synchronization instruction unit 104 transmits, to each of the network device ND1 and the network device ND2, the clock synchronization instruction containing the device information of the other (step S107).

In response to this, the network device ND1 and the network device ND2 which have received the clock synchronization instruction from the clock synchronization instruction unit 104 mutually generate the communication path for the clock synchronization to start the clock synchronization via the IP network (step S108).

In contrast to this, in a case where the network device ND2 serving as the clock master has the medium-precise clock accuracy, the clock synchronization instruction unit 104 needs to instruct the network device ND2 serving as the clock master to undergo the evaluation of the clock accuracy, while giving the clock synchronization instruction.

When the clock synchronization instruction unit 104 transmits the clock synchronization instruction to the network device ND2 (step S109), information on a reference device (in the embodiment, network device ND1), in reference to which the clock accuracy is evaluated, is given thereto in addition to the information on the slave device when being communicated.

Here, the network device ND2 serving as the clock master sets a clock accuracy evaluation timer that evaluates the clock accuracy in a certain cycle (step S110).

Thereafter, the network device ND2 generates the communication path for the clock synchronization between the network device ND2 and the network device ND1 acting as the slave to start the clock synchronization via the IP network.

The clock synchronization instruction unit 104 of the management device 20 notifies a control device CD serving as a device for which the clock accuracy has been guaranteed in advance, of a clock evaluation acceptance request (step S112).

Meanwhile, when the clock accuracy evaluation timer has timed out in the network device ND2 serving as the clock master (step S113), the network device ND2 transmits a clock evaluation start request to the control device CD (step S114).

The control device CD transmits a clock evaluation response to the network device ND2 (step S115), and establishes the communication path for the clock accuracy evaluation between the control device CD and the network device ND2 (step S116).

Thereafter, the network device ND2 notifies the management device 20 of clock accuracy information measured via the communication path for the clock accuracy evaluation as a clock evaluation result notification (step S117).

Consequently, after receiving a notification on a first clock evaluation result, the clock accuracy evaluation unit 105 of the management device 20 evaluates the clock accuracy using the clock accuracy evaluation timer that times out in a certain cycle.

Next, operation for updating the clock synchronization network will be described.

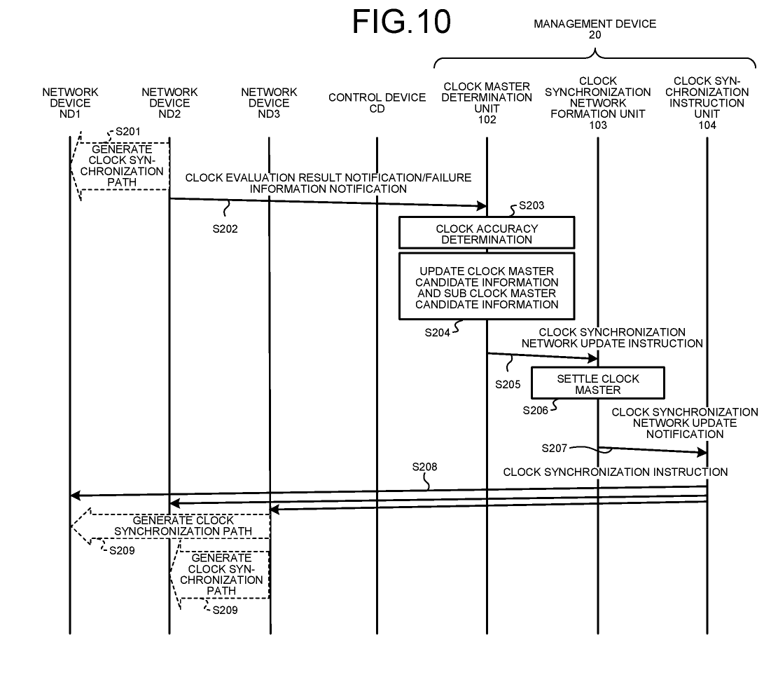

FIG. 10 is an explanatory diagram for an exemplary operation sequence when the clock synchronization network is updated in accordance with the clock accuracy evaluation and the failure information.

First, the network device ND2 generates the communication path for the clock synchronization as the clock master for the network device ND1 serving as the slave (step S201).

Subsequently, when the clock evaluation result notification or the failure information notification is transmitted to the management device 20 from the network device ND2 (step S202), on the basis of the clock accuracy evaluation result notification or the failure information notification that has been received, the clock master determination unit 102 of the management device 20 determines whether the operation thereof as the clock master can be continued (step S203).

Thereafter, in a case where the network device ND2 is determined as being inappropriate as the clock master as a result of the clock accuracy evaluation or in accordance with the failure information, the clock master determination unit 102 updates the clock master candidate information or the sub clock master candidate information (step S204) and then transmits the clock synchronization network update instruction to the clock synchronization network formation unit 103 (step S205).

In response to this, the clock synchronization network formation unit 103 selects a network device ND3 as a new clock master for the network device ND2 and the network device ND1 acting as the slave thereof to assign thereto (step S206).

The clock synchronization network formation unit 103 instructs the clock synchronization instruction unit 104 on the clock synchronization network update notification (step S207).

In response to this, the clock synchronization instruction unit 104 transmits the clock synchronization instruction to the network device ND1, the network device ND2, and the network device ND3 (step S208).

As a result of these, the communication path for the clock synchronization in which the network device ND3 is newly set as the clock master is generated and the clock synchronization via the IP network is started (step S209).

As described above, according to the embodiment, the clock synchronization network can be updated dynamically depending on a state of the clock master or the failure information, whereby it is made possible to form a network enabling the high-precise clock synchronization to be performed continuously.

In the description above, the clock accuracy has been classified into three levels as follows: the high-precise clock accuracy representing enough accuracy to perform the voice communication through the ISDN, the medium-precise clock accuracy that causes no difficulty in performing the voice communication through the ISDN, and the low-precise clock accuracy at such a level that voice quality is deteriorated in the voice communication through the ISDN. However, two divisions, namely, relatively high-precise clock accuracy (including the high-precise and medium-precise clock accuracy described above) and relatively low-precise clock accuracy may be employed. Or conversely, a configuration for the classification into four divisions or more can be employed as well.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A clock synchronization management device, comprising:
an accuracy evaluation unit that evaluates the accuracy of a clock for synchronization with respect to each of devices constituting a decentralization system and classifies each of the devices into a plurality of divisions based on whether each of the devices is capable of supplying at least the clock for synchronization to another device; and
a network formation unit that identifies a device capable of supplying the clock for synchronization based on a classification by the accuracy evaluation unit and causes a device incapable of supplying the clock for synchronization to another device to synchronize with the identified device.

2. The clock synchronization management device according to claim 1, wherein
the accuracy evaluation unit:
classifies a device capable of supplying, to another device, the clock for synchronization having enough accuracy to perform voice communication through an ISDN as a clock master candidate;
classifies a device capable of supplying, to another device, the clock for synchronization having accuracy that causes no difficulty in performing the voice communication through the ISDN as a sub clock master candidate; and
classifies a device incapable of supplying, to another device, the clock for synchronization as a slave.

3. The clock synchronization management device according to claim 1, wherein
when identifying the device capable of supplying the clock for synchronization to use in performing synchronization, the network formation unit causes the device incapable of supplying the clock for synchronization to another device to synchronize with a device estimated to be located geographically close to that device incapable of supplying the clock for synchronization to another device, among a plurality of devices classified into the same division.

4. The clock synchronization management device according to claim 1, wherein
when identifying the device capable of supplying the clock for synchronization to use in performing synchronization, the network formation unit causes the device incapable of supplying the clock for synchronization to another device to synchronize with a device having a smaller number of devices to be supplied with the clock.

5. The clock synchronization management device according to claim 1, wherein
the accuracy evaluation unit reevaluates the accuracy of the clock for synchronization with respect to a device that has been already classified, and
in a case where the accuracy of the clock of the reevaluated device is degraded, the network formation unit newly identifies the device capable of supplying the clock for synchronization based on a new division according to the clock accuracy evaluation unit and causes a device that has synchronized with the device for which the accuracy of the clock has been degraded to synchronize with the newly identified device.

6. The clock synchronization management device according to claim 1, wherein
the network formation unit assigns, to one device incapable of supplying the clock for synchronization to another device, an odd number of the devices capable of supplying the clock for synchronization, where an odd number is equal to or greater than three, and
in a case where inconsistency occurs in the supplied clocks for synchronization, the network formation unit causes the one device incapable of supplying the clock for synchronization to another device to synchronize with one of the clocks for synchronization by majority rule.

7. The clock synchronization management device according to claim 1, further comprising:
a clock master information storage that stores system information on a device classified as a clock master candidate by the accuracy evaluation unit because of being a device capable of supplying, to another device, the clock for synchronization having enough accuracy to perform voice communication through an ISDN, and
a sub clock master information storage that stores system information on a device classified as a sub clock master candidate by the accuracy evaluation unit because of being a device capable of supplying, to another device, the clock for synchronization having accuracy that causes no difficulty in performing the voice communication through the ISDN.

8. A control method for a clock synchronization management device, comprising:
evaluating the accuracy of a clock for synchronization with respect to each of devices constituting a decentralization system;
classifying each of the devices into a plurality of divisions based on whether each of the devices is capable of supplying at least the clock for synchronization to another device;
identifying a device capable of supplying the clock for synchronization based on a classification-performed in the classifying; and
causing a device incapable of supplying the clock for synchronization to another device to synchronize with the identified device.

9. The control method according to claim 8, wherein
the classifying includes
classifying in a device capable of supplying, to another device, the clock for synchronization having enough accuracy to perform voice communication through an ISDN as a clock master candidate,
classifying in a device capable of supplying, to another device, the clock for synchronization having accuracy that causes no difficulty in performing the voice communication through the ISDN as a sub clock master candidate, and
classifying in a device incapable of supplying, to another device, the clock for synchronization as a slave.

10. The control method according to claim 8, wherein
when identifying the device capable of supplying the clock for synchronization to use in performing synchronization, the causing includes causing the device incapable of supplying the clock for synchronization to another device to synchronize with a device estimated to be located geographically close to that device incapable of supplying the clock for synchronization to another device, among a plurality of devices classified into the same division.

11. The control method according to claim 8, wherein
when identifying the device capable of supplying the clock for synchronization to use in performing synchronization, the causing includes causing the device incapable of supplying the clock for synchronization to another device to synchronize with a device having a smaller number of devices to be supplied with the clock.

12. The control method according to claim 8, wherein
the evaluating includes reevaluating the accuracy of the clock for synchronization with respect to a device that has been already classified, and
in a case where the accuracy of the clock of the reevaluated device is degraded, the identifying includes newly identifying the device capable of supplying the clock for synchronization based on a new division according to the classifying and the causing includes causing a device that has synchronized with the device for which the accuracy of the clock has been degraded to synchronize with the newly identified device.

13. The control method according to claim 8, further comprising:
assigning, to one device incapable of supplying the clock for synchronization to another device, an odd number of the devices capable of supplying the clock for synchronization, where an odd number is equal to or greater than three, wherein
in a case where inconsistency occurs in the supplied clocks for synchronization, the causing includes causing the one device incapable of supplying the clock for synchronization to another device to synchronize with one of the clocks for synchronization by majority rule.

14. The control method according to claim 8, further comprising:
storing system information on a device classified as a clock master candidate because of being a device capable of supplying, to another device, the clock for synchronization having enough accuracy to perform voice communication through an ISDN, in a clock master information storage and
storing system information on a device classified as a sub clock master candidate because of being a device capable of supplying, to another device, the clock for synchronization having accuracy that causes no difficulty in performing the voice communication through the ISDN, in a sub clock master information storage.

15. A computer program product including programmed instructions embodied in and stored on a non-transitory computer readable medium, wherein the instructions, when executed by a computer, cause the computer to perform:
evaluating the accuracy of a clock for synchronization with respect to each of the devices constituting the decentralization system;
classifying in each of the devices into a plurality of divisions based on whether each of the devices is capable of supplying at least the clock for synchronization to another device;
identifying a device capable of supplying the clock for synchronization based on a classification performed by the classifying; and
causing a device incapable of supplying the clock for synchronization to another device to synchronize with the identified device.

16-21. (canceled)
